(19) United States
(12) Patent Application Publication
(10) Pub. No.: US 2003/0064674 A1
(43) Pub. Date: Apr. 3, 2003

(54) Gaming device having a removable coin tray

(76) Inventor: Michael O. Parham, Las Vegas, NV (US)

Correspondence Address: Anderson & Morishita, L.L.C., 2725 S. Jones Boulevard, Suite 102, Las Vegas, NV, 89146, US

(21) Appl. No.: 09/967,519

(22) Filed: Sep. 28, 2001

(51) Int. Cl. G07D 9/00

(52) U.S. Cl. 453/63

(57) ABSTRACT

An improved gaming device is set forth having a removable coin and token tray. The tray has rearwardly extending pins and a latch assembly. The device includes a receiver assembly having bores and slots to receive the pins and register with the latch assembly to releasably mount the tray to the device. A lever located in the device when the device is closed and secured manipulates the latch assembly. To release the tray access is required to the interior of the device.

### FIELD OF THE INVENTION

The present invention relates to gaming machines of the type having a forward facing, lower coin tray. More particularly it relates to removable coin trays.

### BACKGROUND

Upright slot machine devices are well know. These machines include an upstanding housing which houses the game processor, power supply, coin hopper, coin dispensing mechanism, and other components that are embraced in a modern slot machine. The housing also mounts the video game display. To gain access to the inside of the machine there is a locked door. Upon unlocking and opening the door, staff can re-fill the coin hopper and repair/replace the various components for the machine.

When a player receives a coin or token pay out or cashes out accumulated credits, the coins/token are dispensed from the coin hopper by a device within the housing which sends the required number of coins to drop into a tray disposed on the front bottom of the machine. The player then retrieves the dispensed coins/tokens from the tray as their pay out.

The coin trays are typically, according to the prior art, made from assembled sheet metal and extend across the bottom of the machine. They are secured to the housing by suitable fasteners such as bolts/nuts, screws and the like and are not intended to be removed.

A drawback to these prior coin trays is that they cannot be easily removed for replacement or repair. In this regard, a repairman may desire to remove the tray to gain easier access to the inside of the housing without having to work over the tray.

There is a need for a coin tray for a slot machine which can be securely fastened to the machine housing, cannot be removed without gaining access to the machine housing thereby requiring authority and which is easily removed for repair, replacement or for the temporary purpose of gaining easier access to the inside of the machine housing.

### SUMMARY OF THE INVENTION

There is, therefore, set forth according to the present invention an improved machine of the type adapted to dispense coins or tokens which includes a removable coin tray and wherein removal of the tray requires access to the inside of the machine housing as by opening the machine door. There is also set forth an improved tray assembly for a slot machine device.

Accordingly there is provided an improved machine of the type which includes a housing with a front opening, a door to close the opening and means for dispensing coins or tokens into a tray. The improvement includes a receiver assembly on the housing which has spaced holes and slots. Preferably the receiver assembly includes a pair of spaced sub-assemblies each having a pair of forward facing holes and orthogonally arranged slots. The tray has a back wall mounting a latch assembly with opposed fingers moveable by a linkage between a first, extended, position and a second, withdrawn, position. A lever manipulates the linkage to the second position against the bias of a spring. The tray also mounts a support assembly including alignment and support pins.

To mount the tray, the door of the machine is opened thereby requiring an access key to unlock the machine door. The alignment pins are located to register with the holes of the receiver assembly. As the tray is moved to position and cam surfaces on the fingers urge the fingers to the second position against the bias of the spring. At a position where the tray mounts to the machine the fingers align with the slots and extend, under the bias of the spring, to the first position into the slots to secure the tray to the machine housing. The door is then closed and locked. The lever, with the door closed, is disposed within the machine housing.

To remove the tray, the door is opened to gain access to the lever. The lever is manipulated to withdraw the fingers to the second position against the bias of the spring to release the tray from the machine.

There is also set forth a tray assembly having the above features and which may be suitable for retrofitting slot machine devices.

Thus, the improvement provides for a device which has a removable tray and wherein removal is secured by requiring access to the interior of the device by unlocking and opening the door thereof.

### BRIEF DESCRIPTION OF THE DRAWINGS

These and other features and advantages will become appreciated as the same becomes understood with reference to the claims, description and drawings wherein:

FIG. 1 is a perspective view of an example of a slot machine with a tray according to the present invention;

FIG.2 is an assembly view of the tray and shows the receiver assembly and latch assembly;

FIG. 3 is a front prospective view of a portion of the receiver assembly;

FIG. 4 is a rear view of the tray showing the latch assembly; and

FIG. 5 is a top view of a latch assembly finger showing the cam surface thereof.

### DESCRIPTION

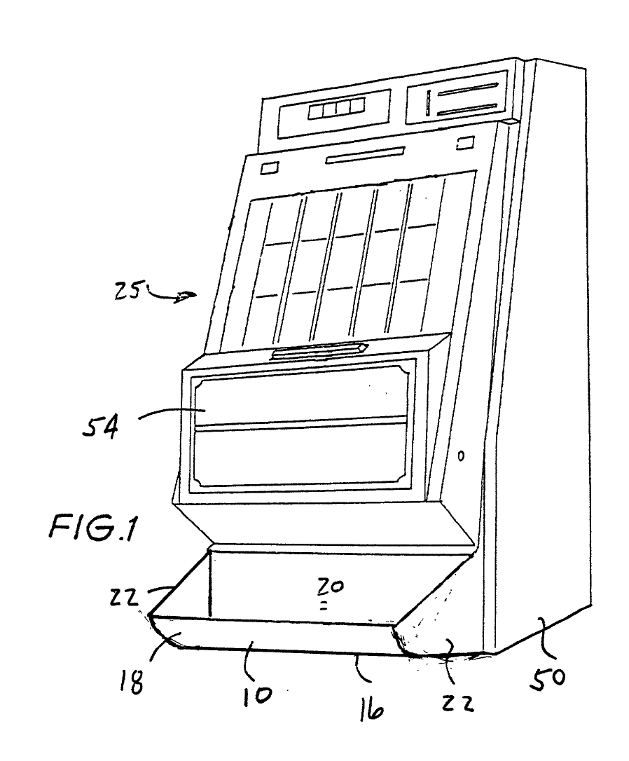

Turning to FIG. 1 there is shown a slot machine device 25 mounting a tray 10 according to the present invention. The device 25 has a housing with a closeable door 54 as is known in the art.

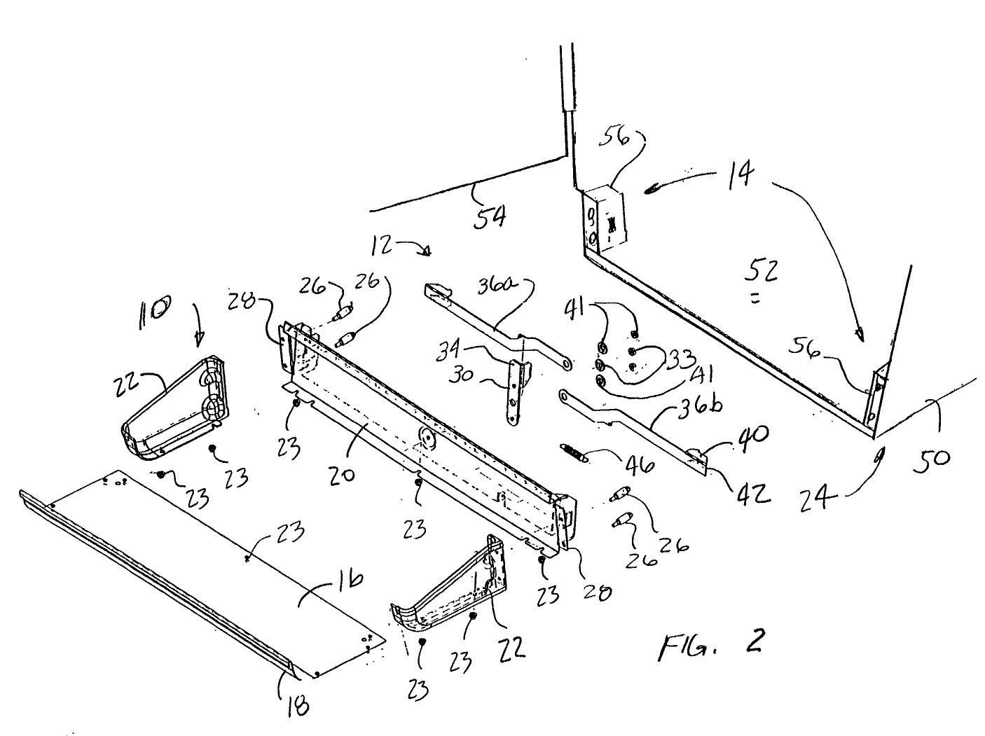

With reference to FIG. 2 there an assembly view of the tray 10, latch assembly 12 and receiver assembly 14 according to the present invention. The tray 10 includes a bottom 16, upstanding front wall 18 and rear wall 20 and opposed side walls 22 which, when assembled as by tack welding, fasteners 23 or the like, define the tray 10 to receive and retain coins or tokens dispensed from a device 25 shown as a gaming machine. The tray 10, as hereinafter described, is removably mounted at the bottom front of the device 25. The user of the device 25 removes, with their hand, the coins/tokens in the tray 10 as is known in the art.

To support and align the tray 10 on the device 25, the tray 10 includes, at opposite ends, projecting pins 26. While only one pin 26 may be provided at each end, preferably, as shown, at each end the tray 10 mounts a pair of vertically spaced, rearwardly directed, pins 26. To mount the pins 26, the tray rear wall 20 has a pair of projecting ears 28.

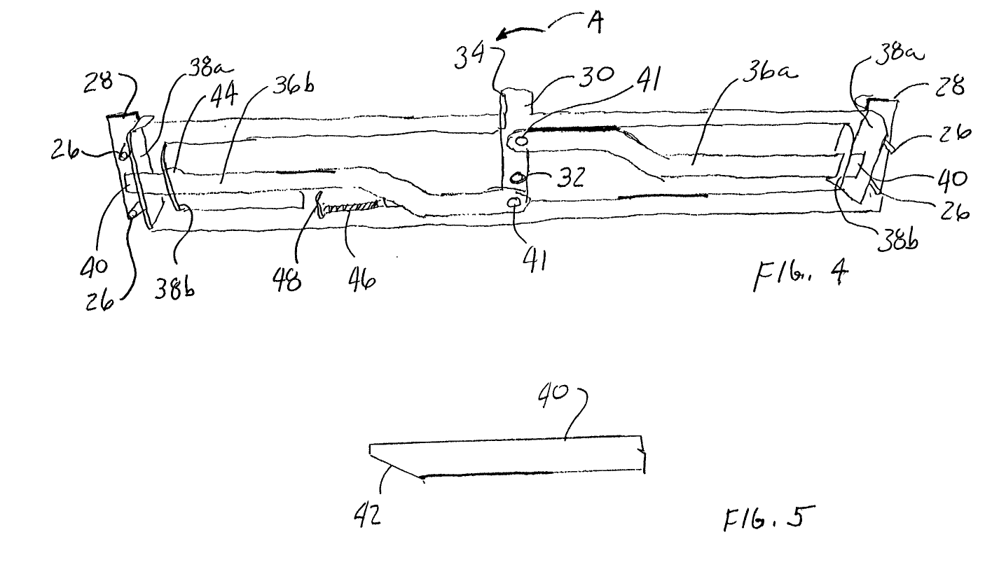

With reference to FIGS. 2 and 4, the tray 10 also mounts the latch assembly 12 disposed on the rear wall 20. The latch assembly includes a pivot arm 30 which is pivotally mounted for counter clockwise rotation (FIG. 4) as suggested by arrow A on a pivot 32 secured to the rear wall 20. Suitable fasteners 33 mount the pivot arm 30 to the pivot 32. At one end, the pivot arm 30 projects above the rear wall to define a purchase area 34 for manipulation of the pivot arm 30.

At opposite sides of the pivot arm 30 there is mounted latch arms 36a, b which project to either side of the pivot arm 30 to pass through first and second guides 38a, b. Each guide 38a, b includes a slot to pass and guide the latch arm 36a, b. At the end of each latch arm 36a,b is a finger 40 having a rearwardly facing cam surface 42 as shown in FIG. 5. Proximate the end of the latch arm 36b there is included a stop 44 to limit the extension of the latch arms 36a, b through the guides 38 a, b. The fingers 40, as shown in FIG. 4, extend between the pins 26. Also as best shown in FIGS. 2 and 4, each latch arm 36a, b is mounted to pivot at an end of the pivot arm 30 by suitable fasteners 41.

To impose a bias upon the pivot arm 30 and latch arms 36a,b, the latch assembly 12 further includes a spring 46 disposed between latch arm 36a and a fixed spring mount 48. The spring 46 acts upon the latch arm 36a and latch assembly 12 to bias the latch arms 36a, b to an extended position whereat the latch arms 36a, b are extended to the sides of the tray 10 to a first position, where the stop 44 engages the guide 38a and the fingers 40 are extended to the sides of the tray 10. Using the purchase area 34, the latch assembly 12 can be manipulated to withdraw the fingers 40 to a second position. Moving the purchase area 34 in a counter clockwise direction in FIG. 4 pivots the pivot arm 30 about the pivot 32 and against the bias of the spring 46 to withdraw the pivot arms 36a, b to the second position. Upon release of the purchase area 34, the spring 46 urges the latch arms 36a, b to return to the extended, first position.

Turning to FIGS. 1, 2 and 3, device 25 includes a closed housing 50 having a front opening 52 closeable by the door 54 hinged to the housing 50. The housing 50 contains the mechanical and electrical components for the device 25. Where the device 25 is a gaming machine, e.g. a slot machine, the housing 50 contains the game processor, power supply, hopper, coin dispenser, game display and other components. When a player desires to have their game winnings dispensed, coins or tokens are dispensed from the game hopper (not shown) and drop into the tray 10. To prevent unauthorized access into the housing 50, the door 54 includes a lock (not shown) and may also be electronically monitored to send an alarm if the door 54 is opened by unauthorized personnel.

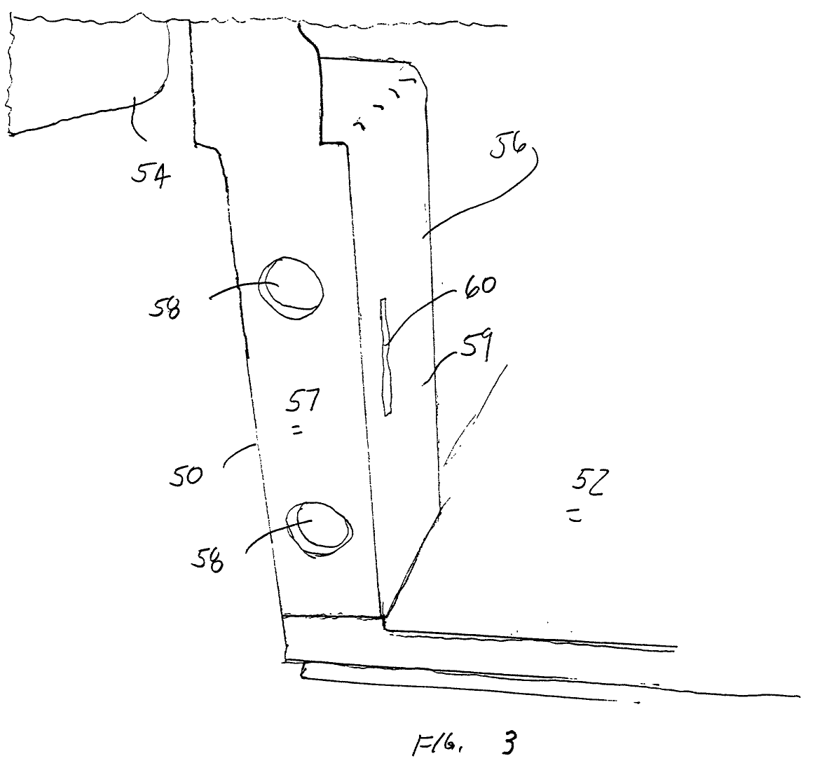

To mount the tray 10, the receiver assembly 14 is provided at the bottom of the housing 50. The receiver assembly 14 includes a pair of subassemblies 56 disposed in the housing 50 proximate the bottom thereof and preferably at opposing sides of the opening 52. Each subassembly 56, with reference to FIG. 3, includes a forward plate 57 and a side plate 59, the forward plate 57 including a pair of forward facing bores 58 arranged and adapted to register with the pins 26. The side plate 59 has a slot 60 disposed rearwardly of the front of the housing 50 and between the bores 58.

To mount the tray 10, the door 54 for the device 24 is unlocked and opened and the pins 26 are aligned with the bores 58. The tray 10 is urged toward the housing 50. The finger cam surfaces 42 engage the forward plate 57 and, in turn, urge the fingers 40 and latch arms 36a, b to withdraw toward the second position. Continued urging of the tray rearwardly registers the pins 26 in the bores 58 and the fingers 40 slide along the side plate 59 until the fingers 40 align with the slots 60. When aligned, and under the bias provided by the spring 46, the fingers 40 engage into the slots 60 to secure the tray 10 to the device 24. The pins 26 provide for alignment and vertical stability for the tray 10 and the fingers 40 engaged in the slots 60 prevent removal of the tray 10 from the device 24. The door 54 is then closed and locked to the housing 50 concealing the lever 34 within the closed device 24 housing 50. Thus, access to the lever 34 for removal of the tray 10 from the device 24 requires that the door 54 be unlocked.

To remove the tray 10, the door 54 is unlocked and opened revealing the purchase area 34. The purchase area 34, from the front, is rotated clock wise against the bias of the spring 46 to withdraw the fingers 40 to the second position disengaging the fingers 40 from the slots 60 and releasing the tray 10. The tray 10 is thereafter pulled form the device 25 to disengage the pins 26 from the bores 58.

As can be appreciated, the pins 26, fingers 40 and receiver assembly 14 are subject to many modifications without departing from the spirit and scope of the present invention. The pins 26 need not be cylindrical or be provided in pairs. They could be, for example, a single pin or tab or any shape as could be the accommodating bore on the receiver assembly 14. Further the receiver subassemblies 56 need not be located at the sides of the housing 50 and could be mounted in any suitable location to receive and mount the tray 10 in position to receive coins/tokens dispensed from the device 25.

The tray assembly according to the present invention is also suitable for being provided as a retrofit assembly of kit which can be installed in existing machines to provide a removeable tray therefore according to the present invention.

While we have shown and described certain embodiments of the present invention, it should be understood that it is subject to many modifications and changes without departing from the spirit and scope of the appended claims.

I claim:

1. An improved gaming device with a removable coin tray, said device including a housing with an opening and a door to close the opening, comprising:
a coin tray having a bottom, a front wall, a rear wall and opposed sides;
a pair of spaced pins projecting from said back wall;
a latch disposed on the rear wall and including a pivot and a pair of arms each having at their ends a finger; and
said device including bores to receive said pins to mount the tray and a slot to receive each finger when the latch is in a first position to secure the tray to the device, said latch in a second position withdrawing said fingers from said slots to release said tray for removal thereof.

2. The improved device of claim 1 comprising said latch including a lever for moving said latch from said first to said second position.

3. The improved device of claim 2 comprising said lever disposed to be concealed within said opening and concealed by closure of said door.

4. The improved device of claim 1 comprising a spring to bias said latch to said first position.

5. The improved device of claim 4 comprising a follower surface on each finger disposed to engage the margins of said slots to move said lever to said second position against said bias of said spring in response to mating said tray to said device.

6. An improved device including means for dispensing coins or tokens, said machine including a housing with a front opening and a door for opening and closing said opening, said improvement comprising:
a receiver assembly disposed withing the housing and including a pair of spaced front bores and slots;
a tray to receive dispensed coins, said tray having a rear wall mounting a latch assembly and at least a pair of pins each disposed to register with one of said front bores to support said tray on said housing and said latch assembly including a pivot mounting opposed arms, each arm disposed to be received into a slot in a first, extended position to secure said tray to the housing and an operating lever to manipulate said fingers to a second position to withdraw said fingers from said slots for removal of said tray.

7. The improved device of claim 6 comprising said lever having a manipulating purchase area disposed to be located within the housing when said door is closed.

8. The improved device of claim 6 comprising a spring coupled between said tray and said latch assembly to bias the fingers to said first position.

9. The improved device of claim 8 comprising each arm including a cam surface to engage the receiver assembly to urge said arms against said bias to said second position when said pins are positioned in said openings, said spring biasing said arms to said first position when said arms are aligned with said slots.

10. The improved device of claim 6 comprising said lever pivotally mounted to said tray and including said arms mounted at either end of said pivot, manipulation of said lever about said pivot withdrawing and extending said fingers.

11. A tray assembly for removeably mounting a coin tray to a device of the type having a housing with an opening, a door to close the opening and a mechanism for dispensing coins, the assembly comprising:
a receiver assembly secured withing the housing and including a pair of spaced front bores and slots;
said tray assembly having a rear wall mounting a latch assembly and at least a pair of pins each disposed to register with one of said front bores to support said tray on said housing and said latch assembly including a pivot mounting opposed arms, each arm disposed to be received into a slot in a first, extended position to secure said tray to the housing and an operating lever to manipulate said fingers to a second position to withdraw said fingers from said slots for removal of said tray.

12. The assembly of claim 11 comprising said lever including a manipulating purchase area disposed to be located within the housing when said door is closed.

13. The assembly of claim 11 comprising a spring coupled between said tray and said latch assembly to bias the fingers to said first position.

14. The assembly of claim 13 comprising each arm including a cam surface to engage the receiver assembly to urge said arms against said bias to said second position when said pins are positioned in said openings, said spring biasing said arms to said first position when said arms are aligned with said slots.

15. The assembly of claim 11 comprising said lever pivotally mounted to said tray and including said arms mounted at either end of said pivot, manipulation of said lever about said pivot withdrawing and extending said fingers.
